(19) United States
(12) Patent Application Publication
(10) Pub. No.: US 2019/0238842 A1
(43) Pub. Date: Aug. 1, 2019

(54) METHOD AND APPARATUS FOR EXTRACTING INTRA PREDICTION MODE INFORMATION OF SQUARE OR RECTANGULAR BLOCK

(71) Applicant: INTELLECTUAL DISCOVERY CO., LTD., Seoul (KR)

(72) Inventors: Ho Chan RYU, Seoul (KR); Yong Jo AHN, Seoul (KR)

(21) Appl. No.: 16/378,494

(22) Filed: Apr. 8, 2019

Related U.S. Application Data
(63) Continuation of application No. PCT/KR2016/011333, filed on Oct. 11, 2016.

(30) Foreign Application Priority Data
Oct. 10, 2016 (KR) 10-2016-0130475

(51) Int. Cl. H04N 19/11; H04N 19/176

(52) U.S. Cl. CPC H04N 19/11; H04N 19/176

(57) ABSTRACT

The present invention relates to a method and apparatus, with respect to a block partitioning scheme from among the video compression schemes, for improving encoding/decoding efficiency by utilizing an intra prediction mode extraction method of a square or rectangular block.

### RELATED APPLICATIONS

This application is a continuation application of the International Patent Application Serial No. PCT/KR2016/011333, filed Oct. 11, 2016, which claims priority to the Korean Patent Application Serial No. 10-2016-0130475, filed Oct. 10, 2016. Both of these applications are incorporated by reference herein in their entireties.

### TECHNICAL FIELD

The present invention relates to an image encoding and decoding scheme and, more particularly, to a method of extracting intra mode information in video decoding method and apparatus using square or rectangular block partitioning.

### BACKGROUND

There is a growing demand for high definition video in the marketplace, and thus a technology capable of efficiently compressing high resolution images is required. Based on such a need in the marketplace, the Moving Picture Expert Group (MPEG) of ISO/IEC and the Image Coding Expert Group of ITU-T jointly established the Joint Collaborative Team on Image Coding (JCT-VC), which led to the development of the high efficiency video coding (HEVC) video compression standard in January 2013. Now, research and development for the next generation compression standard are actively being conducted.

Generally, when an image is partitioned into blocks of a certain size, the current block and neighboring blocks thereto may have similar image characteristics. Using these characteristics, the HEVC encodes the current prediction unit (PU) mode on the basis of modes of the neighboring blocks based on the current PU. The modes of these neighboring blocks are determined by a Most Probable Mode (MPM). When the prediction mode of the current PU is similar to modes of the neighboring PUs, the probability of being determined by the MPM is high and the mode bits can be saved.

### SUMMARY

It is an object of the present invention to provide a method of extracting intra prediction mode information in video decoding method and apparatus using square or rectangular block partitioning.

It is to be understood, however, that the technical scope of the present invention is not limited to the above-described technical problems, and other technical problems may exist.

In order to achieve the object, a video decoding method and apparatus according to an embodiment of the present invention includes extracting information for extracting an intra prediction mode of a square or rectangular block from a bitstream; configuring an MPM list of the square or rectangular block using the extracted information; and determining the intra prediction mode of the square or rectangular block using the configured MPM list.

In order to achieve the object, the video decoding method and apparatus according to an embodiment of the present invention includes extracting information indicating whether the MPM list is used or not for extracting the intra prediction mode of the square or rectangular block from the bitstream; extracting information indicating an MPM index from the bitstream, when the extracted information indicating whether the MPM list is used or not indicates that the MPM list is used; and extracting the intra prediction mode from the bitstream, when the extracted information indicating whether the MPM list is used or not indicates that the MPM list is not used.

In order to achieve the object, the video decoding method and apparatus according to an embodiment of the present invention includes: when information indicating whether an MPM is used or not, acquired from the bitstream, indicates that the MPM is used, configuring the MPM list according to a block shape by determining a shape of a current block; when a duplicated mode exists in the configured MPM list, modifying the MPM list by replacing the duplicated mode with another mode; and when the modified MPM list has not been completed, filling the MPM list with default MPMs.

In order to achieve the object, the video decoding method and apparatus according to an embodiment of the present invention includes determining the intra prediction mode in the configured MPM list using information indicating an MPM index and acquired from the bitstream.

It is an object of the present invention to provide intra prediction mode extraction method and apparatus for a square or rectangular block to improve encoding/decoding efficiency, unlike a mode extraction method used in the existing video compression scheme.

According to the above-described solution of the present invention, the efficiency of the encoder/decoder can be improved by using the intra prediction mode extraction method of the square or rectangular block, thereby improving the video compression performance.

### BRIEF DESCRIPTION OF THE DRAWINGS

FIG. 1 illustrates a decoding apparatus using an intra prediction mode extraction method for a square or rectangular block according to an embodiment of the present invention.

FIG. 2 illustrates a method of extracting intra prediction mode information of a square or rectangular block according to an embodiment of the present invention.

FIG. 3 illustrates a method of configuring an MPM list according to a block shape when extracting an intra prediction mode of a square or rectangular block according to an embodiment of the present invention.

FIG. 4 illustrates orders for configuring an MPM list according to a block shape when extracting an intra prediction mode of a square or rectangular block according to an embodiment of the present invention.

FIG. 5 is a flowchart illustrating an intra prediction mode extraction method of a square or rectangular block according to an embodiment of the present invention.

FIG. 6 is a flowchart illustrating, upon configuring an MPM list for extracting an intra prediction mode of a square or rectangular block, when modes in the MPM list are duplicated, a method of removing the duplicated mode, according to an embodiment of the present invention.

FIG. 7 illustrates a method of signaling intra prediction mode information of a square or rectangular block using coding unit syntax among syntax for an intra prediction mode extraction method of a square or rectangular block according to an embodiment of the present invention.

### DETAILED DESCRIPTION

Hereinafter, embodiments of the present invention will be described in detail with reference to the drawings attached thereto, so that those skilled in the art can easily carry out the present invention. The present invention may, however, be embodied in many different forms and should not be construed as limited to the embodiments set forth herein. In order to clearly illustrate the present invention, parts not related to the description are omitted, and similar parts are denoted by like reference characters throughout the specification.

Throughout this specification, when a part is referred to as being ‘connected’ to another part, it includes not only an example where they are directly connected but also an example where the part is electrically connected with another part in between.

In addition, when a part is referred to as ‘comprising’ an element throughout the specification, it is understood that the element may include other elements as well, without departing from the other elements unless specifically stated otherwise.

The term ‘a step of doing something’ or ‘a step of something’ used throughout this specification does not mean a step for something.

Also, the terms first, second, etc. may be used to describe various components, but the components should not be limited by the terms. The terms are used only for the purpose of distinguishing one component from another.

In addition, the components shown in the embodiments of the present invention are shown independently to represent different characteristic functions, but that does not mean that each component consists of separate hardware or one software constituent unit. That is, each component is described by arranging each component for convenience of explanation, and at least two components of components may be combined to form one component or one component may be partitioned into a plurality of components to perform functions. The integrated embodiments and the separate embodiments of each of these components are also included in the scope of the present invention without departing from the essence of the present invention.

First, terms used in the present application will be briefly described as follows.

Hereinafter, a video decoding apparatus to be described below may be an apparatus included in a server terminal, such as a personal computer (PC), a notebook computer, a portable multimedia player (PMP), a wireless communication terminal, a smart phone, a TV application server, a service server, and the like, and may refer to various apparatus including a user terminal such as various devices, a communication device such as a communication modem for performing communication with a wired/wireless communication network, a memory that stores various programs and information for decoding an image or performing inter or intra prediction for decoding, a microprocessor that executes program to perform operations and controls, and the like.

In addition, the image encoded as bitstream by the encoder may be transmitted to the image decoding apparatus through a wired or wireless communication network such as the Internet, a local area wireless communication network, a wireless LAN network, a WiBro network, a mobile communication network in real time or in non-real time, or through various communication interfaces such as cable, universal serial bus, and the like, and then decoded and restored and reproduced as an image.

Typically, a moving picture may constitute a series of pictures, and each picture may be partitioned into a coding unit such as a block. It is to be understood by those skilled in the art to which the present embodiment pertains that the term picture described below may be substituted for another term having an equivalent meaning such as an image, a frame, and the like.

Hereinafter, embodiments of the present invention will be described in detail with reference to the accompanying drawings. In the description of the present invention, duplicate descriptions will be omitted for the same components.

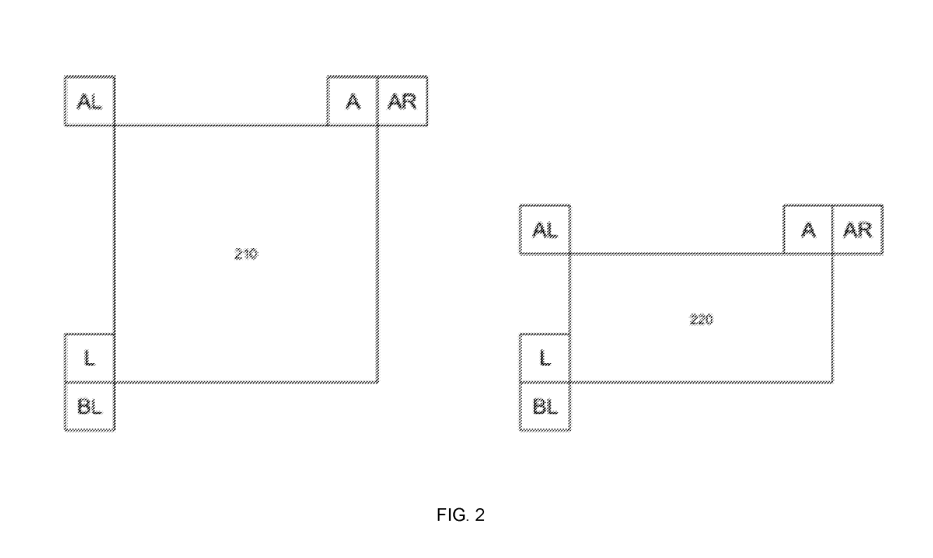

FIG. 2 illustrates a method of extracting intra prediction mode information of a square or rectangular block according to an embodiment of the present invention.

The intra prediction mode of the square block 210 and the rectangular block 220 may be extracted from prediction modes of left L, above A, bottom left BL, above right AR, and above left AL neighboring blocks.

The square block 210 may use the prediction modes of the neighboring blocks L, A, BL, AR, and AL as the prediction modes, and the prediction modes of these neighboring blocks may be included in a Most Probable Mode (MPM) list. The MPM list for the square block 210 may include the prediction modes of the neighboring blocks L, A, BL, AR, AL, and a DC mode, a PLANAR mode.

The rectangular block 220 may use the prediction modes of the neighboring blocks L, A, BL, AR, and AL as the prediction mode, and the prediction modes of the neighboring blocks may be included in the MPM list. The MPM list for the rectangular block 220 may include the prediction modes of the neighboring blocks L, A, BL, AR, AL, and a DC mode, a PLANAR mode.

Hereinafter, embodiments of the present invention will be described in detail with reference to the drawings attached thereto, so that those skilled in the art can easily carry out the present invention. The present invention may, however, be embodied in many different forms and should not be construed as limited to the embodiments set forth herein. In order to clearly illustrate the present invention, parts not related to the description are omitted, and similar parts are denoted by like reference characters throughout the specification.

Throughout this specification, when a part is referred to as being ‘connected’ to another part, it includes not only an example where they are directly connected but also an example where the part is electrically connected with another part in between.

In addition, when a part is referred to as ‘comprising’ an element throughout the specification, it is understood that the element may include other elements as well, without departing from the other elements unless specifically stated otherwise.

The term ‘a step of doing something’ or ‘a step of something’ used throughout this specification does not mean a step for something.

Also, the terms first, second, etc. may be used to describe various components, but the components should not be limited by the terms. The terms are used only for the purpose of distinguishing one component from another.

In addition, the components shown in the embodiments of the present invention are shown independently to represent different characteristic functions, and that does not mean that each component consists of separate hardware or one software constituent unit. That is, each component is described by arranging each component for convenience of explanation, and at least two components of components may be combined to form one component or one component may be partitioned into a plurality of components to perform functions. The integrated embodiments and the separate embodiments of each of these components are also included in the scope of the present invention without departing from the essence of the present invention.

First, terms used in the present application will be briefly described as follows.

Hereinafter, a video decoding apparatus to be described below may be an apparatus included in a server terminal, such as a personal computer (PC), a notebook computer, a portable multimedia player (PMP), a wireless communication terminal, a smart phone, a TV application server, a service server, and the like, and may refer to various apparatus including a user terminal such as various devices, a communication device such as a communication modem for performing communication with a wired/wireless communication network, a memory that stores various programs and information for decoding an image or performing inter or intra prediction for decoding, a microprocessor that executes program to perform operations and controls, and the like.

In addition, the image encoded as bitstream by the encoder may be transmitted to the image decoding apparatus through a wired or wireless communication network such as the Internet, a local area wireless communication network, a wireless LAN network, a WiBro network, a mobile communication network in real time or in non-real time, or through various communication interface such as cable, universal serial bus, and the like, and then decoded and restored and reproduced as an image.

Typically, a moving picture may constitute a series of pictures, and each picture may be partitioned into a coding unit such as a block. It is to be understood by those skilled in the art to which the present embodiment pertains that the term picture described below may be substituted for another term having an equivalent meaning such as an image, a frame, and the like.

Hereinafter, embodiments of the present invention will be described in detail with reference to the accompanying drawings. In the description of the present invention, duplicate descriptions will be omitted for the same components.

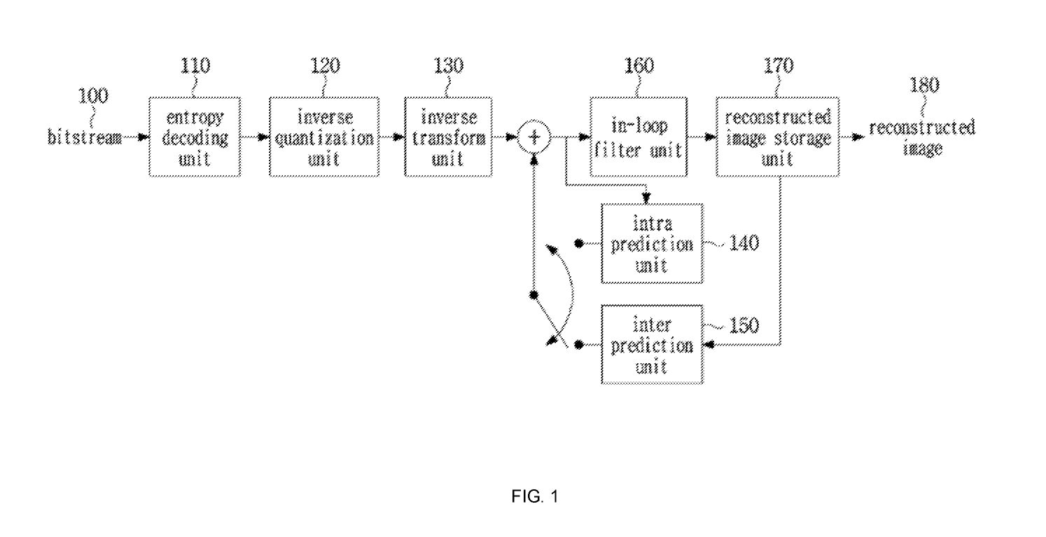

FIG. 1 illustrates a decoding apparatus using an intra prediction mode extraction method for a square or rectangular block according to an embodiment of the present invention.

The decoding apparatus using an intra prediction mode extraction method for a square or rectangular block may include at least one of an entropy decoding unit 110, an inverse quantization unit 120, an inverse transform unit 130, an intra prediction unit 140, an inter prediction unit 150, an in-loop filter unit 160, and a reconstructed image storage unit 170.

The entropy decoding unit 110 decodes the input bitstream 100 and outputs decoding information such as syntax elements, quantized coefficients, and the like. The decoding information to be output may include information for extracting an intra prediction mode of the square or rectangular block.

The inverse quantization unit 120 and the inverse transform unit 130 receive the quantization coefficients, and perform inverse quantization and inverse transformation in order, thereby outputting a residual signal.

The intra prediction unit 140 performs spatial prediction using pixel values of pre-reconstructed neighboring blocks adjacent to the current block to be decoded, thereby generating a prediction signal. The generating of the prediction signal includes the intra prediction mode extraction method for the square or rectangular block.

The inter prediction unit 150 performs motion compensation using motion vector extracted from the bitstream and a reconstructed image stored in the reconstructed image storage unit 170, thereby generating a prediction signal.

The prediction signals output from the intra prediction unit 140 and the inter prediction unit 150 are summed with the residual signal, and the reconstructed image generated through the summation is transmitted to the in-loop filter unit 160.

The reconstructed picture to which the filtering is applied in the in-loop filter unit 160 may be stored in the reconstructed image storage unit 170 and used as a reference picture in the inter prediction unit 150.

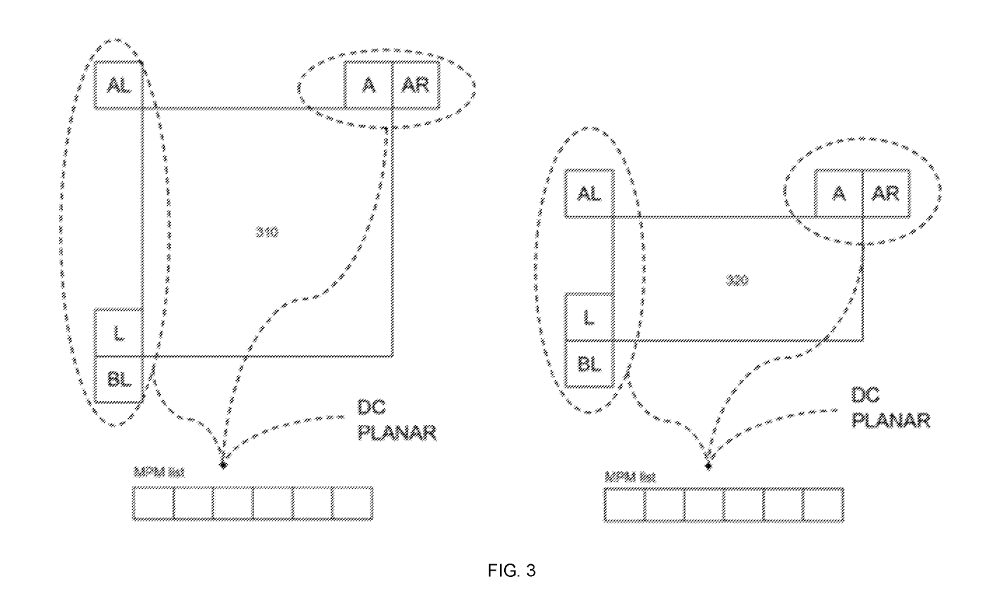

FIG. 3 illustrates a method of configuring an MPM list according to a block shape when extracting an intra prediction mode of a square or rectangular block according to an embodiment of the present invention.

The MPM list of the square block or the rectangular block may be filled with the prediction mode of the neighboring block, the DC mode, and the PLANAR mode, and the number of modes capable of being filled may be six.

The MPM list of the square block 310 may be filled in the order of the mode having a higher probability of occurrence of the prediction modes of the neighboring blocks L, A, BL, AR, and AL, the DC mode and the PLANAR mode.

The MPM list of the rectangular block 320 may be filled in the order of the mode having a higher probability of occurrence of the prediction modes of the neighboring blocks L, A, BL, AR, and AL, the DC mode and the PLANAR mode, and the order may be different from the order of the MPM list in the square block.

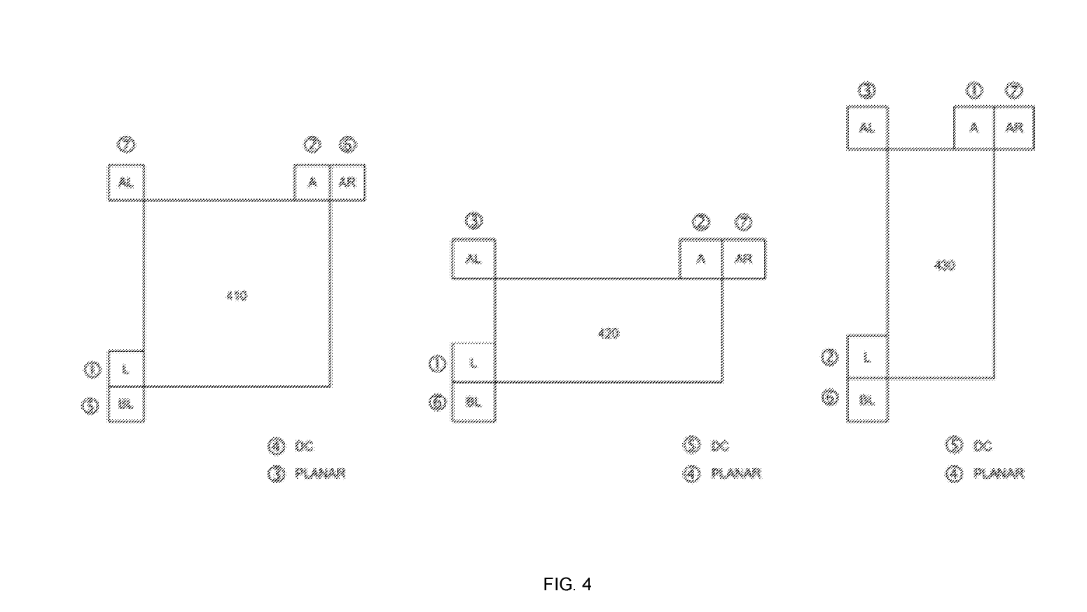

FIG. 4 illustrates orders for configuring an MPM list according to a block shape when extracting an intra prediction mode of a square or rectangular block according to an embodiment of the present invention.

A MPM list of a square block 410 may be filled in the order of the mode of the neighboring block L, the mode of the neighboring block A, the PLANAR mode, the DC mode, the mode of the neighboring block BL, the mode of the neighboring block AR, and the mode of the neighboring block AL.

A MPM list of a horizontally long rectangular block 420 may be filled in the order of the mode of the neighboring block L, the mode of the neighboring block A, the mode of a neighboring block AL mode, the PLANAR mode, the DC mode, the mode of the neighboring block BL, and the mode of the neighboring block AR.

A MPM list of a vertically long rectangular block 430 may be filled in the order of the mode of the neighboring block A, the mode of the neighboring block L, the mode of the neighboring block AL, the PLANAR mode, the DC mode, the mode of the neighboring block BL, and the mode of the neighboring block AR.

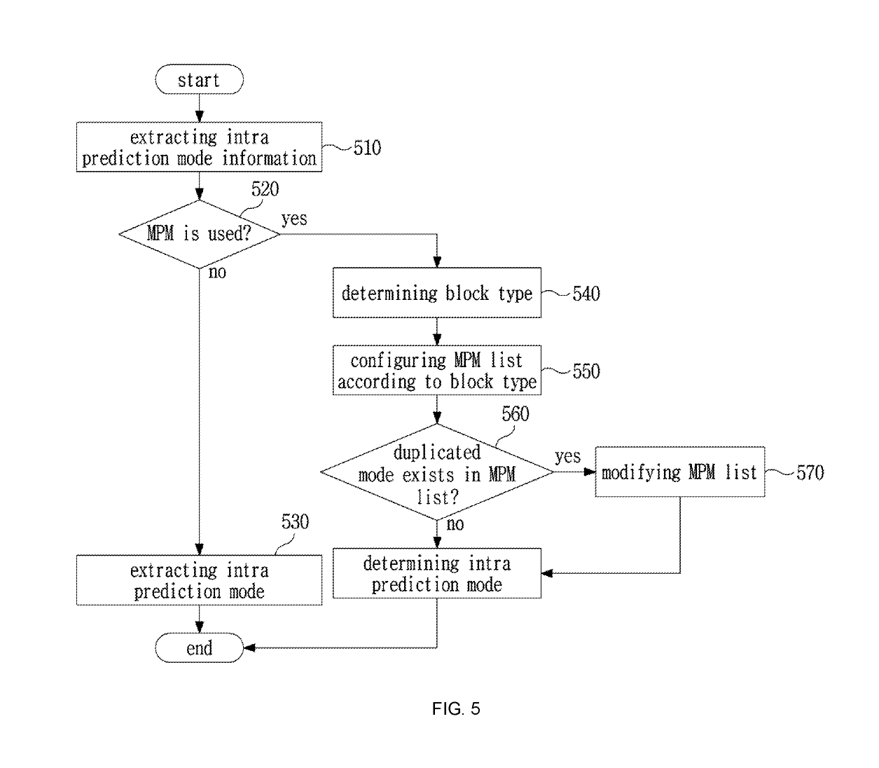

FIG. 5 is a flowchart illustrating an intra prediction mode extraction method for a square or rectangular block according to an embodiment of the present invention.

The process of the intra prediction mode extraction method for a square or rectangular block is as follows. First, information for the intra prediction mode extraction is extracted from the bitstream 510. The extracted information may include information indicating whether the MPM is used or not and an MPM index indicating a mode in the MPM list used by the encoder. After the information is extracted, it is determined, based on the extracted information, whether the MPM is used or not 520. When MPM is not used, the intra prediction mode is extracted from the bitstream 530. When the MPM is used, it is determined whether the current block is a square block or a rectangular block 540. The MPM list is configured according to a shape of the block 550. The MPM list is configured with modes having a higher probability of occurrence depending on the block shape. It is determined whether duplicated mode exists in the configured MPM list 560. When the duplicated mode exists, the MPM list is modified by removing the duplicated mode and replacing the same with another mode 570. Finally, the intra prediction mode is determined, from the completed MPM list, using the MPM index extracted from the bitstream 580.

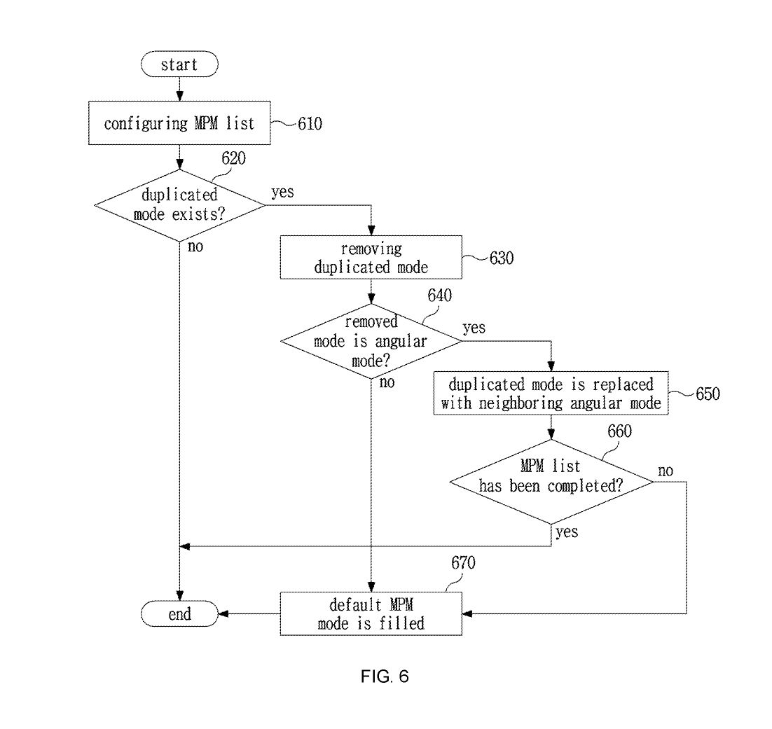

FIG. 6 is a flowchart illustrating, upon configuring an MPM list for extracting an intra prediction mode of a square or rectangular block, when modes in the MPM list are duplicated, a method of removing the duplicated mode, according to an embodiment of the present invention.

When configuring an MPM list for extracting an intra prediction mode of a square or rectangular block, the modes of neighboring blocks are identical to each other, so that duplicated modes may exist in the MPM list. In this case, one mode of the duplicated identical modes may be removed from the MPM list, and the removed mode may be replaced with another mode.

In the case that the removed mode of the duplicated identical modes is replaced with another mode, when the removed mode is the angular mode, the removed mode may be replaced with a neighboring mode of the corresponding angular mode. For example, when the removed mode is the mode 5, the removed mode 5 may be replaced with the mode 4 or the mode 6.

When the MPM list is not full even when the duplicated mode is removed, the MPM list may be filled with the default MPM modes. The default MPM mode may be a PLANAR mode, a DC mode, a vertical direction mode, a horizontal direction mode, a mode 2, a diagonal direction mode. The order in the MPM list may be varied depending on a square block, a horizontally long rectangular block or a vertically long rectangular block.

Referring to the order of configuring the MPM list, the MPM list is configured according to a shape of the square or rectangular block 610. It is determined whether the duplicated mode exists in the configured MPM list 620, and when the duplicated mode exists, the duplicated mode is removed 630. It is determined whether the removed mode is the angular mode 640, and when the removed mode is the angular mode, the neighboring mode of the removed mode is inserted in the MPM list 650. Here, the neighboring mode may be a mode of the removed angular mode−1 or the removed angular mode+1. After it is determined again whether the MPM list has been completed 660, when the MPM list is not completed yet, the process of filling the MPM list with the default MPM modes is performed 670.

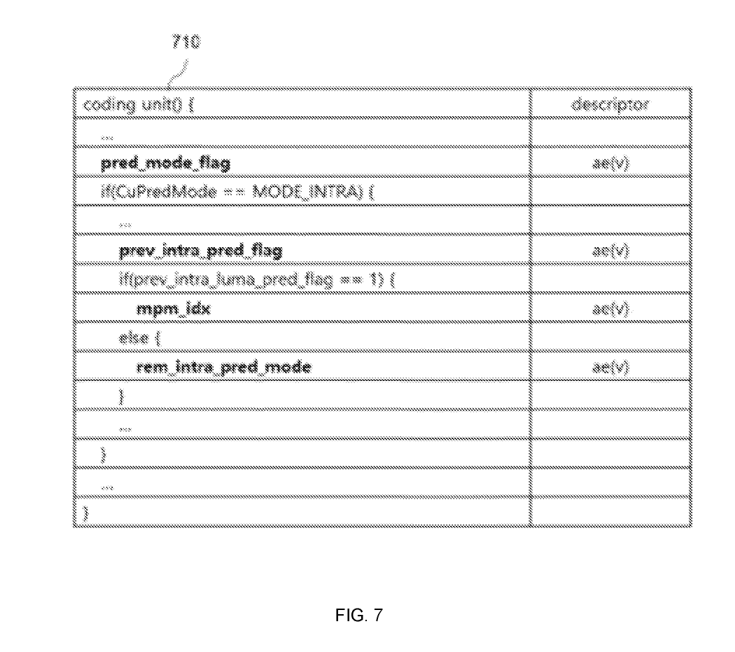

FIG. 7 illustrates a method of signaling intra prediction mode information of a square or rectangular block using coding unit syntax among syntax for an intra prediction mode extraction method for a square or rectangular block according to an embodiment of the present invention.

The proposed intra prediction mode extraction method for the square or rectangular block may include information for an intra prediction mode extraction of a square or rectangular block in a coding unit syntax 710 of a network abstraction layer (NAL) existing in the compressed bitstream.

‘Wed mode flag’ indicates whether the current block uses the intra prediction or not. When the current block uses the intra prediction, ‘prev_intra_pred_flag’ indicating whether the current block uses the MPM or not may be included. When the current block uses the MPM, ‘mpm_idx’ indicating an index that indicates a mode in the MPM list used by the encoder may be included. When the current block does not use the MPM, ‘rem_intra_pred_mode’ indicating the intra prediction mode used by the encoder may be included.

The present invention can be used for broadcasting equipment manufacturing, terminal manufacturing, and the like, and for industries related to source technology.

What is claimed is:

1. A video decoding method, comprising:
extracting information for extracting an intra prediction mode of a square or rectangular block from a bitstream;
configuring an MPM list of the square or rectangular block using the extracted information; and
determining the intra prediction mode of the square or rectangular block using the configured MPM list.

2. The method of claim 1, wherein extracting the information for extracting the intra prediction mode of the square or rectangular block from the bitstream comprises:
extracting information indicating whether the MPM list is used or not for extracting the intra prediction mode of the square or rectangular block from the bitstream;
extracting information indicating an MPM index from the bitstream, when the information indicating whether the MPM list is used or not indicates that the MPM list is used; and
extracting the intra prediction mode from the bitstream, when the information indicating whether the MPM list is used or not indicates that the MPM list is not used.

3. The method of claim 1, wherein configuring the MPM list of the square or rectangular block using the extracted information comprises:
when information, acquired from the bitstream, indicating whether an MPM is used or not indicates that the MPM is used, determining a shape of a current block to configure the MPM list according to a block shape;
when a duplicated mode exists in the configured MPM list, modifying the MPM list by replacing the duplicated mode with a neighboring mode; and
when the modified MPM list has not been completed, filling the MPM list with default MPMs.

4. The method of claim 1, wherein determining the intra prediction mode of the square or rectangular block using the configured MPM list comprises:
determining the intra prediction mode in the configured MPM list using information, acquired from the bitstream, indicating an MPM index.

5. A video decoding apparatus, performing:
extracting information for extracting an intra prediction mode of a square or rectangular block from a bitstream;
configuring an MPM list of the square or rectangular block using the extracted information; and
determining the intra prediction mode of the square or rectangular block using the configured MPM list.

6. The apparatus of claim 5, wherein extracting the information for extracting the intra prediction mode of the square or rectangular block from the bitstream comprises:
extracting information indicating whether the MPM list is used or not for extracting the intra prediction mode of the square or rectangular block from the bitstream;
extracting information indicating an MPM index from the bitstream, when the information indicating whether the MPM list is used or not indicates that the MPM list is used; and
extracting the intra prediction mode from the bitstream, when the information indicating whether the MPM list is used or not indicates that the MPM list is not used.

7. The apparatus of claim 5, wherein configuring the MPM list of the square or rectangular block using the extracted information comprises:
when information, acquired from the bitstream, indicating whether an MPM is used or not indicates that the MPM is used, determining a shape of a current block to configure the MPM list according to a block shape;
when a duplicated mode exists in the configured MPM list, modifying the MPM list by replacing the duplicated mode with another mode; and
when the modified MPM list has not been completed, filling the MPM list with default MPMs.

8. The apparatus of claim 5, wherein determining the intra prediction mode of the square or rectangular block using the configured MPM list comprises:
determining the intra prediction mode in the configured MPM list using information, acquired from the bitstream, indicating an MPM index.
